(19) United States
(12) Patent Application Publication
(10) Pub. No.: US 2009/0080931 A1
(43) Pub. Date: Mar. 26, 2009

(54) AUXILIARY POWER SUPPLY APPARATUS

(75) Inventor: Makoto Takahashi, Izu-shi (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/861,558

(22) Filed: Sep. 26, 2007

(51) Int. Cl. G03G 15/00

(52) U.S. Cl. 399/88

(57) ABSTRACT

An auxiliary power supply apparatus according to an example of the invention includes a first charge storage unit connected in parallel to an external resistance, a second charge storage unit connected in parallel to the external resistance, and a first switch to change a state in which the first charge storage device and the second charge storage device are connected in parallel to the external resistance to a state in which the first charge storage device and the second charge storage device are connected in series to the external resistance.

### BACKGROUND OF THE INVENTION

1. Field of the Invention

The present invention relates to an auxiliary power supply apparatus used for an image forming apparatus having a copying machine or the like.

2. Description of the Related

As is well known, in recent years, there is an image forming apparatus having plural functions such as a copy function, a facsimile function, a scanner function and a printer function. In the copy function of the image forming apparatus, for the purpose of improving usability and saving energy, a technique to shorten a time from an ON state of a power supply or a waiting state to a usable state is adopted. For example, in the image forming apparatus, an auxiliary power supply apparatus is provided. In the image forming apparatus, there is adopted a method in which both energy from the auxiliary power supply apparatus and energy from an electric lamp line are used, and the temperature of a fixing unit is raised to a rated value in a short time. The auxiliary power supply apparatus is provided with a charge storage device such as a secondary battery which can be quickly charged, and supplies electric power to a halogen heater.

However, at room temperature, the inner resistance of the halogen heater is several ohms or not larger than 1 ohm. Thus, in the system in which the charge storage device and the halogen heater are directly connected as in the related art, the inrush current several tens times larger than the rating flows through the halogen heater at the instant of turning ON. There is a fear that the large inrush current damages the charge storage device or a switch. Thus, there has been a problem that a protection circuit is required and a large-capacity charge storage device is required.

Accordingly, the invention provides an auxiliary power supply apparatus which suppresses inrush current to a halogen heater as an external resistance.

### BRIEF SUMMARY OF THE INVENTION

An auxiliary power supply apparatus of the invention includes a first charge storage unit connected in parallel to an external resistance, a second charge storage unit connected in parallel to the external resistance, and a first switch to change a state in which the first charge storage device and the second charge storage device are connected in parallel to the external resistance to a state in which the first charge storage device and the second charge storage device are connected in series to the external resistance.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing an outer appearance of an image forming apparatus in which an auxiliary power supply apparatus of an embodiment of the invention is used.

FIG. 2 is a block diagram showing a main structure of the image forming apparatus in which the auxiliary power supply apparatus of the embodiment of the invention is used.

FIG. 3 is a view showing a fixing unit including a halogen heater connected to the auxiliary power supply apparatus of the embodiment of the invention.

FIG. 4 is a view showing a connection between the halogen heater and the auxiliary power supply apparatus of the embodiment of the invention.

### DETAILED DESCRIPTION OF THE INVENTION

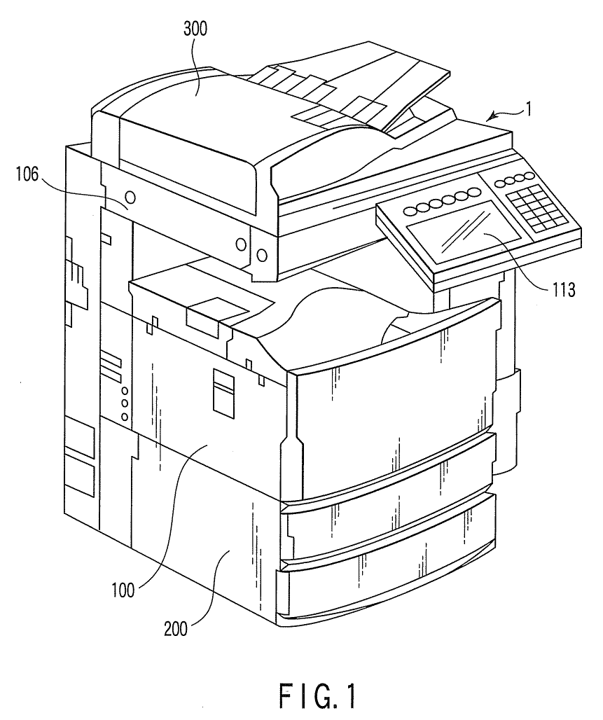

An embodiment of the invention will be described with reference to the drawings. FIG. 1 shows a main part of an image forming apparatus 1 (hereinafter referred to as an MFP) to which the invention can be applied. The structure of the MFP 1 will be described. The MFP 1 shown in FIG. 1 includes an image forming unit main body 100 to output image information as, for example, an output image called a hard copy or a printout, a sheet supply unit 200 capable of supplying a sheet (output medium) of an arbitrary size, which is used for image output, to the image forming unit main body 100, and a scanner 106 to capture, as image data, image information, which is an object of image formation in the image forming unit main body 100, from an object (hereinafter referred to as an original document) having the image information. Incidentally, the scanner 106 is provided integrally with an automatic document feeder 300 which, in the case where the original document is sheet-like, after the end of formation of image output or capture (hereinafter referred to as reading) of image information, discharges the original document, the reading of which is ended, from a reading position to a discharge position, and guides a next original document to the reading position. Besides, an instruction input unit to instruct a start of image formation in the image forming unit main body 100 or a start of reading the image information of an original document by the scanner 106, that is, a control panel (operation unit) 113 is provided at a specified position of the MFP 1, for example, at the end of the front of the scanner 106.

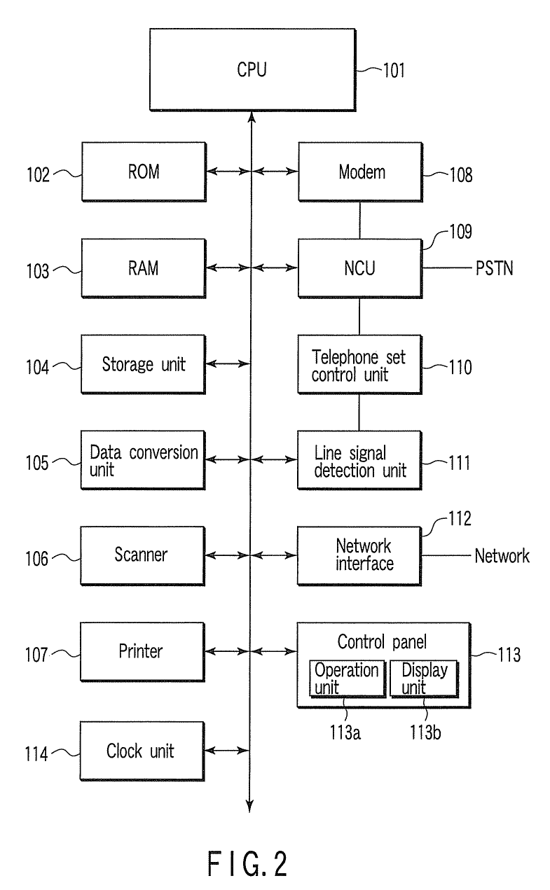

FIG. 2 is a block diagram showing the main structure of the MFP 1. The MFP 1 includes a CPU 101, a ROM 102, a RAM 103, a storage unit 104, a data conversion unit 105, a scanner 106, a printer 107, a modem 108, an NCU 109, a telephone set control unit 110, a line signal detection unit 111, a network interface 112 and a control panel 113.

The CPU 101, the ROM 102, the RAM 103, the storage unit 104, the data conversion unit 105, the scanner 106, the printer 107, the modem 108, the NCU 109, the line signal detection unit 111, the network interface 112, the control panel 113 and a clock unit 114 are mutually connected through a bus line 114. Besides, the modem 108 and the telephone set control unit 110 are connected to the NCU 109. Further, the line signal detection unit 111 is connected to the telephone set control unit 110.

The CPU 101 as control means performs a control processing to overall control the respective parts based on a control program stored in the ROM 102, and realizes the operation as the MFP 1. The ROM 102 records the control program and the like of the CPU 101. The RAM 103 is used as a work area for storing various information required for the CPU 101 to perform various processings. The storage unit 104 is, for example, a hard disk drive device (HDD). The storage unit 104 temporarily stores image data, and records data relating to various settings. The data conversion unit 105 performs an encoding processing for redundancy compression on the image data, and decodes the image data on which the encoding for redundancy compression is performed. The scanner 106 reads a transmitted original document, and generates image data representing the transmitted original document. The printer 107 prints an image represented by the print data onto a recording sheet.

The modem 108 modulates the image data to generate a facsimile transmission signal, and modulates a command given from the CPU 101 to generate a command transmission signal. The modem 108 sends these transmission signals through the NCU 109 to a public telephone line (PSTN subscriber line). The PSTN subscriber line contained in the PSTN is connected to the NCU 109. The NCU 109 performs setting of a level of the facsimile transmission signal to be sent to the PSTN subscriber line. An external telephone set is connected to the telephone set control unit 110 as required. The line signal detection unit 111 receives a signal, which comes through the PSTN subscriber line, through the NCU 109 and the telephone set control unit 110, and detects the coming of a specified signal.

The network interface 112 is used for connection to a network. The network interface 112 receives a print job of print data from a PC connected through the network. Besides, the network interface 112 performs data transmission through the network. The control panel 113 includes an operation unit 113a to receive user's various instruction inputs to the CPU 101, and a display unit 113b to display various information to be notified to the user under control of the CPU 101.

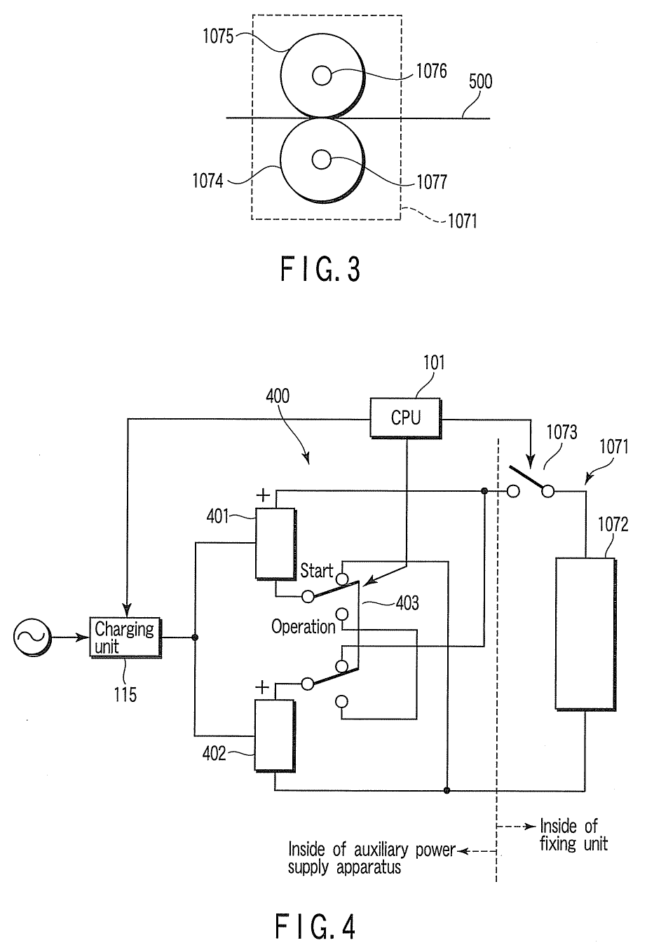

As described above, the printer 107 prints, for example, an image represented by print data from the external PC connected through the network onto a print sheet 500. A fixing unit 1071 constituting the printer 107 will be described by use of FIG. 3. The fixing unit 1071 includes a fixing roller 1075 and a pressure roller 1074. The fixing roller 1075 incorporates a heater 1075. Besides, the pressure roller 1074 also incorporates a halogen heater 1072.

In the printer 107, the print sheet 500 on which a toner image corresponding to an image to be printed is thermally fixed by the fixing unit 500 and is outputted. The fixing roller 1075 is a roller at the side where it comes in contact with the toner image transferred on the print sheet 500. Besides, the pressure roller 1074 is a roller at the side where it comes in contact with the back surface of the print sheet 500. When the print sheet 500 passes through the fixing unit 1071, the toner image transferred on the print sheet 500 is heated by the fixing roller 1075 heated by the heater 1075 and the pressure roller 1074 heated by the halogen heater 1072. Then, the fixing unit 1071 thermally fixes the toner image to the print sheet 500.

Here, the heater 1075 incorporated in the fixing roller 1075 is supplied with electric power from a commercial power supply. Since a larger electric power is consumed for heating of the heater 1075, when the electric power consumed by the MFP 1 is considered, it is difficult to supply electric power from the commercial power supply to the halogen heater 1072 incorporated in the pressure roller 1074. Thus, a separately provided auxiliary power supply apparatus 400 supplies electric power to the halogen heater 1072 incorporated in the pressure roller 1074.

The auxiliary power supply apparatus 400 connected to the halogen heater 1072 will be described by use of FIG. 4. The auxiliary power supply apparatus 400 is connected to the halogen heater 1072 through a switch 1073 as switch means. When the printer 107 prints an image, in order to start the fixing apparatus 1071, the CPU 101 short-circuits the switch 1073 to supply electric power to the halogen heater 1072.

The auxiliary power supply apparatus 400 includes a charge storage unit 401 and a charge storage unit 402 as charge storage means, and a switch 403 as switch means. The charge storage unit 401 and the charge storage unit 402 are, for example, secondary batteries or capacitors. The charge storage unit 401 and the charge storage unit 402 are connected to a charging unit 115. The charging unit 115 is connected to a commercial power supply, and is controlled by the CPU 101. The CPU 101 controls to charge the charge storage unit 401 and the charge storage unit 402 at an arbitrary timing.

Besides, a positive electrode of the charge storage unit 401 is connected to the switch 1073 connected to the halogen heater 1072, and a negative electrode of the charge storage unit 402 is connected to the halogen heater 1072. A negative electrode of the charge storage unit 401 and a positive electrode of the charge storage unit 402 are connected to the switch 403 of the auxiliary power supply apparatus 400. The switch 403 of the auxiliary power supply apparatus 400 is controlled by the CPU 101. The switch 403 can change a state in which the charge storage unit 401 and the charge storage unit 402 are connected in series to the halogen heater 1072 to a state in which the charge storage unit 401 and the charge storage unit 402 are connected in parallel to the halogen heater 1072. This switch 403 may be a mechanical switch or an electric switch.

The voltage of the charge storage unit 401 and the charge storage unit 402 is made half of the rated voltage of the halogen heater 1072. Besides, a material whose impedance is changed according to temperature is used for the halogen heater 1072. The halogen heater 1072 has a low impedance at room temperature, and the impedance becomes high when electric power is supplied and heat is generated. That is, the inner resistance of the halogen heater 1072 is several ohms or not larger than 1 ohm when it is not operated (in the case of room temperature). Thus, when the rated voltage is applied to the halogen heater 1072, a large current several tens times larger than the rated current flows at the instant when the switch 403 is turned ON.

In the case where the charge storage unit 401 and the charge storage unit 402 are connected in series to the halogen heater 1072, the voltages of the charge storage unit 401 and the charge storage unit 402 are added together, and the voltage equal to the rated voltage of the halogen heater 1072 is supplied. In the case where the charge storage unit 401 and the charge storage unit 402 are connected in parallel to the halogen heater 1072, the voltage which is equal to the voltage of the charge storage unit 401 (or the charge storage unit 402) and is half of the rated voltage of the halogen heater 1072 is supplied. Thus, in the case where the charge storage unit 401 and the charge storage unit 402 are connected in parallel to the halogen heater 1072, a current twice larger than a current flowing through each of the charge storage unit 401 and the charge storage unit 402 flows through the halogen heater 1072.

In order to suppress the current flowing through the halogen heater 1072, the charge storage unit 401, the charge storage unit 402, the switch 1073 and the switch 403 at the instant when the switch 403 is turned ON, when the fixing unit 1071 is started, the CPU 101 controls the switch 403 so that the charge storage unit 401 and the charge storage unit 402 are connected in parallel to the halogen heater 1072. That is, the auxiliary power supply apparatus 400 supplies the voltage of half of the rated voltage of the halogen heater 102 to the halogen heater 1072.

The CPU 101 can control the switch 403, which changes the state in which the charge storage unit 401 and the charge storage unit 402 are connected in parallel to the halogen heater 1072 to the state in which the charge storage unit 401 and the charge storage unit 402 are connected in series to the halogen heater 1072, as, for example, described below. For example, the CPU 101 monitors the impedance of the halogen heater 1072. The impedance of the halogen heater 1072 becomes high in proportion to temperature rise by being supplied with electric power from the auxiliary power supply apparatus 400. Thus, the CPU 101 can change the switch 403 when the impedance of the halogen heater 1072 exceeds a specified value. Then, the auxiliary power supply apparatus 400 can supply the rated voltage to the halogen heater 1072. This state reaches the rated state after several seconds.

Besides, for example, the storage unit 104 or the like previously stores impedance versus time characteristic information obtained when electric power is supplied to the halogen heater 1072. Since a time after the start of power supply when the impedance reaches a specified value is determined by this information, the CPU 101 can change the state in which the charge storage unit 401 and the charge storage unit 402 are connected in parallel to the halogen heater 1072 to the state in which the charge storage unit 401 and the charge storage unit 402 are connected in series to the halogen heater 1072 after a specified time has passed. Then, the auxiliary power supply apparatus 400 can supply the rated voltage to the halogen heater 1072. This state reaches the rated state after several seconds.

By the structure as described above, as compared with the case where electric power is supplied to the halogen heater 1072 by a charge storage unit of a voltage equal to the rated voltage of the halogen heater 1072, the inrush current flowing through the charge storage unit 401 (or the charge storage unit 402) can be reduced to ¼.

For example, it is assumed that the rated voltage of the halogen heater 1072 is 48 V. Besides, it is assumed that the impedance of the halogen heater 1072 at normal temperature is 2ω. In the related art, since the voltage of the charge storage unit is equal to the rated voltage of the halogen heater 1072, the inrush current is 48÷2=24 A. In this embodiment, the voltage of each of the charge storage unit 401 and the charge storage unit 402 is 24 V. Thus, at the instant when the switch 403 is turned ON so that the charge storage unit 401 and the charge storage unit 402 are connected in parallel to the halogen heater 1072, a voltage of 24 V is supplied from the auxiliary power supply apparatus 400 to the halogen heater 1072. Thus, the inrush current flowing through the auxiliary power supply apparatus 400 becomes 24÷2=12 A. Then, the inrush current flowing through the charge storage unit 401 and the charge storage unit 402 becomes 12÷2=6 A.

That is, in this embodiment, the peak current flowing through the charge storage unit 401 and the charge storage unit 402 can be greatly reduced. As a result, this embodiment provides the highly reliable structure in which the inrush current to the charge storage unit 401 and the charge storage unit 402 is suppressed, and no load is applied to the auxiliary power supply apparatus 400 and the switch 1073. Thus, the rate of failure occurrence of the auxiliary power supply apparatus 400 can be reduced and the life can be prolonged. Besides, it becomes unnecessary to increase the capacity of the auxiliary power supply apparatus 400, and the auxiliary power supply apparatus 400 and the MFP 1 can be miniaturized.

Additional advantages and modifications will readily occur those skilled in the art. Therefore, the invention in its broader aspects is not limited to the specific details and representative embodiments shown and described herein. Accordingly, various modifications may be made without departing from the spirit or scope of the invention as defined by the appended claims and equivalents thereof.

What is claimed is:

1. An auxiliary power supply apparatus comprising:
a first charge storage unit connected in parallel to an external resistance;
a second charge storage unit connected in parallel to the external resistance; and
a first switch to change a state in which the first charge storage device and the second charge storage device are connected in parallel to the external resistance to a state in which the first charge storage device and the second charge storage device are connected in series to the external resistance.

2. An auxiliary power supply apparatus comprising:
first charge storage means connected in parallel to an external resistance;
second charge storage mean connected in parallel to the external resistance; and
first switch means for changing a state in which the first charge storage means and the second charge storage means are connected in parallel to the external resistance to a state in which the first charge storage means and the second charge storage means are connected in series to the external resistance.

3. An image forming apparatus using a power supply apparatus as recited in claim 1, comprising:
a second switch to switch on or off a connection between one terminal of the first charge storage unit and the external resistance; and
a control unit to switch the first switch at a specified timing.

4. An image forming apparatus using a power supply apparatus as recited in claim 2, comprising:
second switch means for switching on or off a connection between one terminal of the first charge storage means and the external resistance; and
control means for switching the first switch means at a specified timing.

5. The auxiliary power supply apparatus according to claim 1, wherein the first switch performs changeover in a case where an impedance of the external resistance exceeds a specified value.

6. The auxiliary power supply apparatus according to claim 2, wherein the first switch means performs changeover in a case where an impedance of the external resistance exceeds a specified value.

7. The image forming apparatus according to claim 3, wherein the control unit switches the first switch in a case where an impedance of the external resistance exceeds a specified value.

8. The image forming apparatus according to claim 4, wherein the control means switches the first switch means in a case where an impedance of the external resistance exceeds a specified value.

9. The auxiliary power supply apparatus according to claim 1, wherein a rated voltage of the first charge storage unit and the second charge storage unit is half of a rated current of the connected external resistance.

10. The auxiliary power supply apparatus according to claim 2, wherein a rated voltage of the first charge storage means and the second charge storage means is half of a rated current of the connected external resistance.

11. The image forming apparatus according to claim 3, wherein a rated voltage of the first charge storage unit and the second charge storage unit is half of a rated current of the connected external resistance.

12. The image forming apparatus according to claim 4, wherein a rated voltage of the first charge storage means and the second charge storage means is half of a rated current of the connected external resistance.

13. An auxiliary power supply connection method, comprising
changing, at a specified timing, a state in which a first charge storage unit is connected in parallel to an external resistance and a second charge storage unit is connected in parallel to the external resistance to a state in which the first charge storage device and the second charge storage device are connected in series to the external resistance.

14. The auxiliary power supply connection method according to claim 13, wherein
changing the state in which the first charge storage device and the second charge storage device are connected in parallel to the external resistance to the state in which the first charge storage device and the second charge storage device are connected in series to the external resistance in a case where an impedance of the external resistance exceeds a specified value.
